(19) United States
(12) Patent Application Publication
(10) Pub. No.: US 2026/0302659 A1
(43) Pub. Date: Oct. 1, 2026

(54) PRESS FIT CONNECTOR

(71) Applicant: OUPIIN ELECTRONIC (KUNSHAN)CO., LTD., Kunshan City (CN)

(72) Inventor: Hsin Chih CHEN, Kunshan City (CN)

(21) Appl. No.: 19/267,530

(22) Filed: Jul. 12, 2025

(30) Foreign Application Priority Data
Apr. 1, 2025 (CN) 202520600087.X

(51) Int. Cl. H01R 12/58

(52) U.S. Cl. CPC H01R 12/585

(57) ABSTRACT

A press fit connector is disclosed in this application. The press fit connector includes an insulation case, a plurality of first power terminals, a plurality of second power terminals, a plurality of first signal terminals, a plurality of second power terminals, a first support plate and a second support plate. The first support plate is positioned between the first power terminal and the second power terminal to provide isolation between them and provide support for the second power terminal. The second support plate is positioned between the first signal terminal and the second signal terminal to provide isolation between them and provide support for the second signal terminal. The press fit connector of the present application can be safely pressed onto the circuit board.

### CROSS REFERENCE TO RELATED APPLICATIONS

This application claims priority to and the benefit of Chinese Patent Application No. 202520600087.X, filed Apr. 1, 2025, the entirety of which is hereby incorporated herein by reference.

### FIELD OF ART

The present application relates to a field of connector technology, and more specifically to a press fit connector.

### BACKGROUND OF DISCLOSURE

A press fit connector can be pressed by a specific tool (such as a crimping fixture), and press the fit pins of the conductive terminals are pressed into the plated through holes of a circuit board. Electrical connection between the press fit pins and the plated through holes can be achieved without welding or soldering, which not only avoids thermal damage caused by welding or soldering, but also reduces assembly costs.

However, as the density of the conductive terminals in the press fit connector increases, when the press fit pins of the conductive terminals are pressed into the plated through holes, the conductive terminals maybe deform and come into contact with adjacent terminals, even causing irreversible damage.

Hence, it is necessary to provide a new press fit connector to overcome the above-mentioned defects.

### BRIEF SUMMARY OF DISCLOSURE

One object of the present application is to provide a press fit connector, which can be safely pressed onto a circuit board and has good power transmission and signal transmission functions.

Other objects and advantages of the present application may be further understood from technical features disclosed by the present application.

To achieve the above objects of the present application, the present application adopts the following technical solution.

A press fit connector comprises an insulation case, a plurality of first power terminals, a plurality of second power terminals, a plurality of first signal terminals, a plurality of second signal terminals, a first support plate and a second support plate. The insulation case has a slot for inserting an insert. Each first power terminal has a first elastic arm, a first retaining section, a first horizontal section and a first vertical section arranged in sequence. The first vertical section disposes a first power press fit pin. Each second power terminal has a second elastic arm, a second retaining section, a second horizontal section and a second vertical section arranged in sequence. The second vertical section disposes a second power press fit pin. Wherein, the first elastic arm and the corresponding second elastic arm extend into the slot, are arranged vertically, and form a clamping shape to clamp the insert. The first horizontal section and the corresponding second horizontal section are arranged vertically and form a first spacing. Each first signal terminal has a first front arm, a first locking section, a first transverse section and a first longitudinal section arranged in sequence. The first longitudinal section disposes a first signal press fit pin. Each second signal terminal has a second front arm, a second locking section, a second transverse section and a second longitudinal section arranged in sequence. The second longitudinal section disposes a second signal press fit pin. Wherein, the first front arm and the corresponding second front arm extend into the slot, are arranged vertically, and form a clamping shape to clamp the insert. The first transverse section and the corresponding second transverse section are arranged vertically and form a second spacing. The first support plate has a plurality of first support grooves arranged in a row and located in the first spacing; wherein the second horizontal section of each second power terminal is embedded in the corresponding first support groove. The second support plate has a plurality of second support grooves arranged in a row and located in the second spacing; wherein the second transverse section of each second signal terminal is embedded in the corresponding second support groove.

In one embodiment, each of the first support grooves has an L-shaped cross-section along the second horizontal section, and a U-shaped cross-section perpendicular to the second horizontal section. Each of the second support grooves has an L-shaped cross-section along the second transverse section, and a U-shaped cross-section perpendicular to the second transverse section.

In one embodiment, the insulation case has a mating side, a terminal insertion side, an installation side and a pressure application side. The mating side is arranged opposite to the terminal insertion side; the installation side is arranged opposite to the pressure application side; and the installation side is perpendicular to the mating side and the terminal insertion side. The slot is formed on the mating side. The first vertical sections, the second vertical sections, the first longitudinal sections and the second longitudinal sections are exposed on the terminal insertion side. The first power press fit pins, the second power press fit pins, the first signal press fit pins and the second signal press fit pins are located on the terminal insertion side and extend toward the installation side.

In one embodiment, the insulation case has a power terminal placement area and a signal terminal placement area adjacent to each other. In the power terminal placement area, the insulation case includes: a power cover plate, a first vertical wall and a second vertical wall. The power cover plate is located on the pressure application side, extend in a direction away from the mating side, and is used to cover the first power terminal and the second power terminal. The first vertical wall and the second vertical wall face each other, are located below the power cover plate and are vertically connected to the power cover plate. Wherein, the first vertical wall and the second vertical wall are each provided with a first holding groove; and wherein, two ends of the first support plate are each provided with a first protrusion rib, which can slide into the first holding groove for fixing the first support plate to the insulation case.

In one embodiment, in the signal terminal placement area, the insulation case is provided with: an opening, a third vertical wall and a fourth vertical wall. The opening is located on the pressure application side and is adjacent to the power cover plate. The third vertical wall and the fourth vertical wall face each other, are located on two sides of the opening and are parallel to the first and second vertical walls. Wherein, the third vertical wall and the fourth vertical wall are each provided with a second holding groove; and two ends of the second support plate are each provided with a second protrusion rib, which can slide into the second holding groove for fixing the second support plate to the insulation case.

In one embodiment, the insulation case is provided with a partition plate located between the power terminal placement area and the signal terminal placement area; and the second vertical wall and the third vertical wall are two opposite side walls of the partition plate.

In one embodiment, the insulation case is provided with a first bearing block and a second bearing block, which are disposed on two ends of the insulation case, are located on the terminal insertion side and extend in a direction away from the mating side. Wherein, the first bearing block is located below the power cover plate, and one side wall of the first bearing block facing the partition plate is the first vertical wall. Wherein, the second bearing block and the partition plate are arranged opposite to each other and define the opening; one side wall of the second bearing block facing the partition plate is the fourth vertical wall.

In one embodiment, the insulation case is provided with two positioning posts, which are respectively located on bottom surfaces of the first bearing block and the second bearing block and extend toward the installation side.

In one embodiment, the press fit connector further comprises a terminal seat, which is provided with a plurality of position holes for positioning the first signal terminals and the second signal terminals, and two latch arms disposed on two ends of the terminal seat. Wherein, the first and second press fit pins extend out from a bottom surface of the terminal seat; and the third vertical wall and the fourth vertical wall are each provided with a fastening groove; each latch arm enters into the corresponding fastening groove for fixing the terminal seat on the insulation case; each fastening groove is communicated with the corresponding second holding groove; the second protruding rib passes through the fastening groove and enters into the second holding groove.

In one embodiment, in the power terminal placement area, the insulation case is provided with a plurality of first power terminal-receiving slots and a plurality of second power terminal-receiving slots. The first power terminal-receiving slots are arranged in a row and pass through the mating side and the terminal insertion side for receiving the first power terminals. The second power terminal-receiving slots are arranged in a row and pass through the mating side and the terminal insertion side for receiving the second power terminals. Wherein, the power cover plate, the first vertical wall and the second vertical wall surround the first power terminal-receiving slots and the second power terminal-receiving slots on the terminal insertion side. In the signal terminal placement area, the insulation case is provided with: a plurality of first signal terminal-receiving slots and a plurality of second signal terminal-receiving slots. The first signal terminal-receiving slots are arranged in a row and pass through the mating side and the terminal insertion side for receiving the first signal terminals. The second signal terminal-receiving slots are arranged in a row and pass through the mating side and the terminal insertion side for receiving the second signal terminals. Wherein, the opening, the third vertical wall and the fourth vertical wall surround the first signal terminal-receiving slots and the second signal terminal-receiving slots on the terminal insertion side.

In one embodiment, the first power press fit pins, the second power press fit pins, the first signal press fit pins and the second signal press fit pins are all eyelet-type press fit pins.

In one embodiment, the first retaining section and the second retaining section are parallel to each other and forms a third spacing, and the third spacing is greater than the first spacing; the first locking section and the second locking section are parallel to each other and forms a fourth spacing, and the fourth spacing is greater than the second spacing; wherein, the third spacing is less than the fourth spacing, and the first spacing is greater than the second spacing.

In comparison with the prior art, the press fit connector of the present application can be safely pressed onto the circuit board by providing the first support plate and the second support plate. The first support plate and the second support plate can ensure that the power terminals of the press fit connector can provide good power transmission function, while the signal terminals thereof can provide good signal transmission function.

### BRIEF DESCRIPTION OF DRAWINGS

FIGS. 1 to 3 are perspective schematic views of a press fit connector according to one embodiment of the present application, shown from different angles;

FIG. 4 is an exploded view of the press fit connector according to one embodiment of the present application;

FIG. 5 is a perspective schematic view of a first power terminal and a second power terminal according to one embodiment of the present application;

FIG. 6 is a perspective schematic view of a first signal terminal and a second signal terminal according to one embodiment of the present application;

FIG. 7 is a perspective schematic view of an insulation case, a first support plate, a second support plate and a terminal seat according to one embodiment of the present application;

FIG. 8 is a perspective schematic view of the insulation case according to one embodiment of the present application;

FIG. 9 is a perspective schematic view mainly showing the position relationship of the power terminal, the signal terminal, the first support plate, the second support plate, and the terminal seat;

FIG. 10 is a perspective sectional view of the press fit connector according to one embodiment of the present application, showing the position relationship between the power terminal and the first support plate;

FIG. 11 is a plan sectional view of the press fit connector according to one embodiment of the present application, showing the position relationship between the power terminal and the first support plate;

FIG. 12 is a perspective sectional view of the press fit connector according to one embodiment of the present application, showing the position relationship between the signal terminal and the second support plate; and

FIG. 13 is a plan sectional view of the press fit connector according to one embodiment of the present application, showing the position relationship between the signal terminal and the second support plate.

### DETAILED DESCRIPTION OF PREFERRED EMBODIMENTS

The following description of every embodiment with reference to the accompanying drawings is used to exemplify a specific embodiment, which may be carried out in the present application. Directional terms mentioned in the present application, such as “top”, “bottom”, “front”, “back”, “left”, “right”, “upper”, “lower” etc., are only used with reference to the orientation of the accompanying drawings. Therefore, the used directional terms are intended to illustrate, but not to limit, the present application.

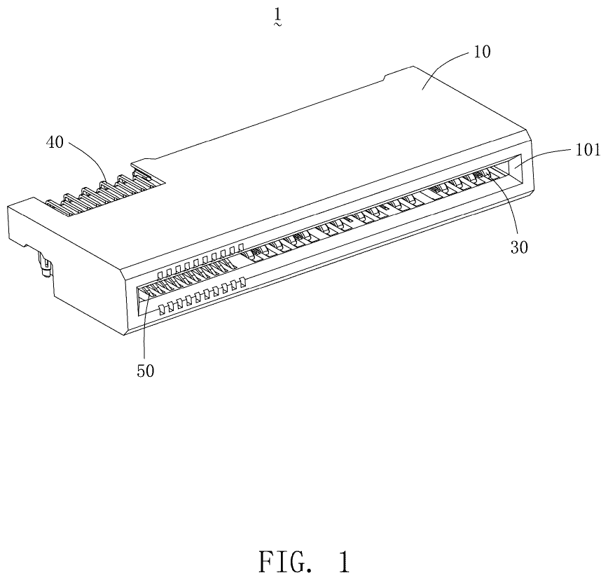

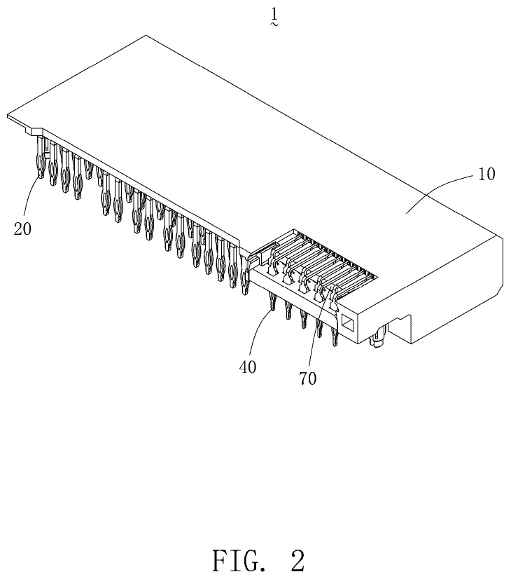

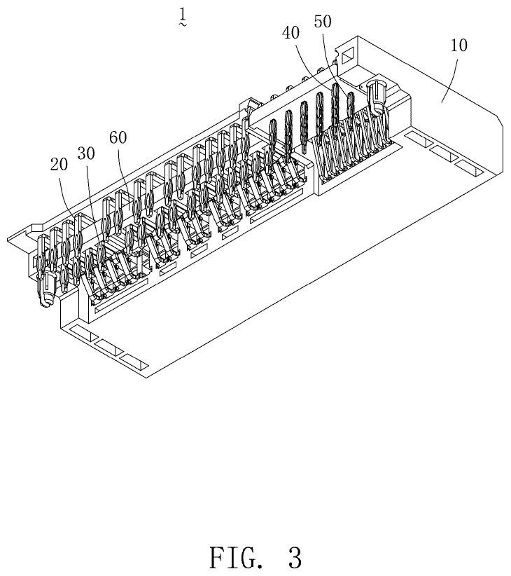

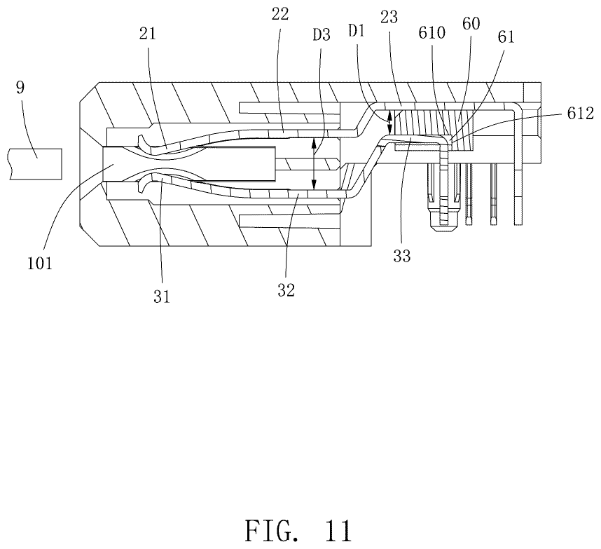

Please refer to FIGS. 1 to 4, a press fit connector 1 includes an insulation case 10, a plurality of first power terminals 20, a plurality of second power terminals 30, a plurality of first signal terminals 40, a plurality of second signal terminals 50, a first support plate 60 and a second support plate 70. The insulation case 10 has a slot 101 for inserting an insert 9 (seen in FIG. 11). In the embodiment, the insert 9 may be an electrical card. In other embodiments, the insert 9 may be a plug connector.

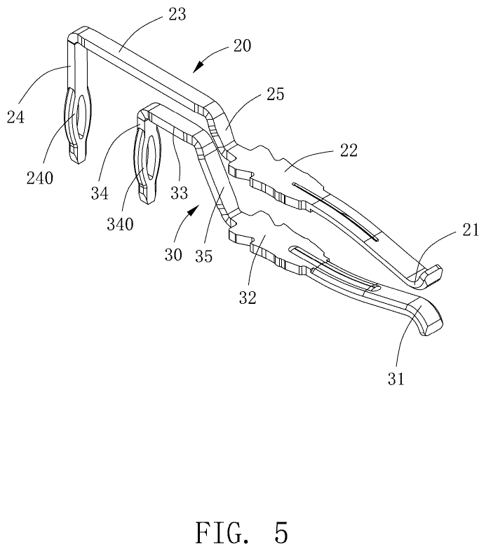

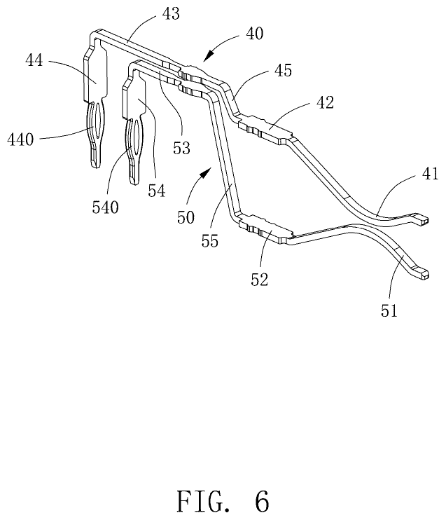

Please refer to FIGS. 5 and 6, each first power terminal 20 has a first elastic arm 21, a first retaining section 22, a first horizontal section 23 and a first vertical section 24 arranged in sequence. The first vertical section 24 disposes a first power press fit pin 240. Each second power terminal 30 has a second elastic arm 31, a second retaining section 32, a second horizontal section 33 and a second vertical section 34 arranged in sequence. The second vertical section 34 disposes a second power press fit pin 340. Each first signal terminal 40 has a first front arm 41, a first locking section 42, a first transverse section 43 and a first longitudinal section 44 arranged in sequence; the first longitudinal section 44 disposes a first signal press fit pin 440. Each second signal terminal 50 has a second front arm 51, a second locking section 52, a second transverse section 53 and a second longitudinal section 54 arranged in sequence. The second longitudinal section 54 disposes a second signal press fit pin 540.

As shown in FIG. 11, the first elastic arm 21 and the corresponding second elastic arm 31 extend into the slot 101, are arranged vertically, and form a clamping shape to clamp the insert 9. The first horizontal section 23 and the corresponding second horizontal section 33 are arranged vertically and form a first spacing D1 therebetween. In the embodiment, the first retaining section 22 and the second retaining section 32 are parallel to each other and forms a third spacing D3 therebetween, and the third spacing D3 is greater than the first spacing D1. By configuring different spacings, the press fit connector 1 of the present application forms a recessed mounting configuration or a low-profile connector, which can save space above a circuit substrate.

More specifically, for the first power terminals 20 and the second power terminals 30, the first vertical sections 24 are arranged in a row, and the second vertical sections 34 are arranged in a row. Each first vertical section 24 and the corresponding second vertical section 34 are arranged front-to-back.

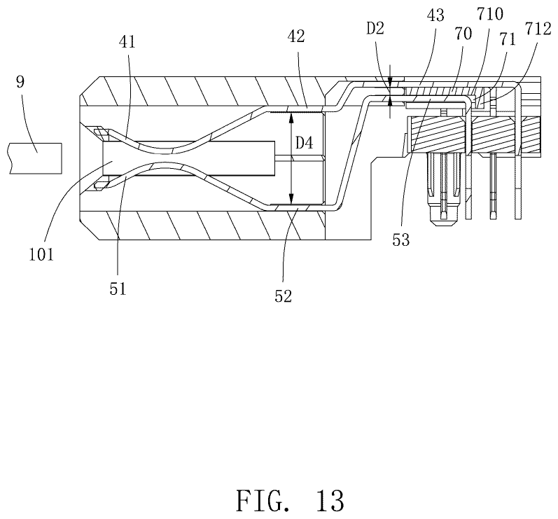

As shown in FIG. 13, the first front arm 41 and the corresponding second front arm 51 extend into the slot 101, are arranged vertically, and form a clamping shape to clamp the insert 9. The first transverse section 43 and the corresponding second transverse section 53 are arranged vertically (top-to-bottom) and form a second spacing D2 therebetween. In the embodiment, the second spacing D2 is less than the first spacing D1. In the embodiment, the first locking section 42 and the corresponding second locking section 52 are parallel to each other and forms a fourth spacing D4 therebetween, and the fourth spacing D4 is greater than the second spacing D2. By configuring these different spacings, the press fit connector 1 of the present application can further form the recessed mounting configuration or the low-profile connector, which can save space above the circuit substrate.

More specifically, for the first signal terminals 40 and the second signal terminals 50, the first longitudinal sections 44 are arranged in two rows, and the second longitudinal sections 54 are arranged in two rows. Each first longitudinal section 44 and the corresponding second longitudinal section 54 are arranged front-to-back.

In the embodiment, as shown in FIG. 5, the first power terminal 20 further has a first transition section 25 connecting the first retaining section 22 and the first horizontal section 23. The second power terminal 30 further has a second transition section 35 connecting the second retaining section 32 and the second horizontal section 33. By disposing the first transition section 25 and the second transition section 35, a variation in the spacing between the first power terminal 20 and the second power terminal 30 can be achieved. Moreover, the first power press fit pins 240 and the second power press fit pins 340 are all eyelet-type press fit pins.

In the embodiment, as shown in FIG. 6, the first signal terminal 40 further has a first connection section 45 connecting a first locking section 42 and the first transverse section 43. The second signal terminal 50 further has a second connection section 55 connecting a second locking section 52 and the second transverse section 53. By disposing the first connection section 45 and the second connection section 55, a variation in the spacing between the first signal terminal 40 and the second signal terminal 50 can be achieved. Moreover, the first signal press fit pins 440 and the second signal press fit pins 540 are all eyelet-type press fit pins.

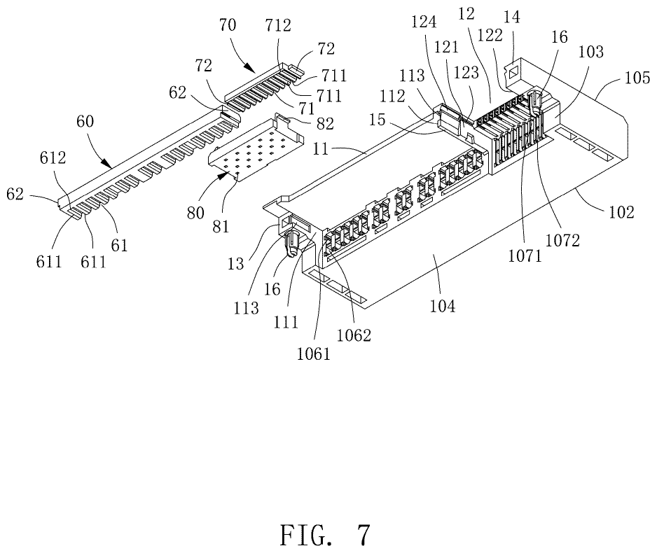

Please refer to FIGS. 7, 10, and 11, the first support plate 60 has a plurality of first support grooves 61 arranged in a row and located in the first spacing D1. The second horizontal section 33 of each second power terminal 30 is embedded in the corresponding first support groove 61. In the embodiment, as shown in FIG. 11, the first support grooves 61 has an L-shaped cross-section along the second horizontal section 33, and has a U-shaped cross-section perpendicular to the second horizontal section 33. Specifically, the first support groove 61 has a first inner top surface 610, two first inner side surfaces 611 and a first inner rear surface 612. The first support groove 61 can provide support or restraint in four directions for the second horizontal section 33, thereby better protecting the second power terminal 30 and preventing its deformation.

Please refer to FIGS. 7, 12, and 13, the second support plate 70 has a plurality of second support grooves 71 arranged in a row and located in the second spacing D2. The second transverse section 53 of each second signal terminal 50 is embedded in the corresponding second support groove 71. The second support groove 71 has an L-shaped cross-section along the second transverse section 53, and a U-shaped cross-section perpendicular to the second transverse section 53. Specifically, the second support groove 71 has a second inner top surface 710, two second inner side surfaces 711 and a second inner rear surface 712. The second support groove 71 can provide support or restraint in four directions for the second transverse section 53, thereby better protecting the second signal terminal 50 and preventing its deformation.

As can be seen from the above, the press fit connector 1 of the present ap plication is provided with the first support plate 60 between the first power terminals 20 and the second power terminals 30. When the press fit connector 1 is pressed onto a circuit board, the first support plate 60 can provide support for the second power terminals 30, thereby ensuring that there is no contact between the two rows of power terminals, and further ensuring that the two rows of power terminals can provide good power transmission function. Moreover, the press fit connector 1 of the present application is also provided with the second support plate 70 between the first signal terminals 40 and the second signal terminals 50. When the press fit connector 1 is pressed onto the circuit substrate, the second support plate 70 can provide support for the second signal terminals 50, thereby preventing deformation of the two rows of signal terminals and affecting their signal transmission function.

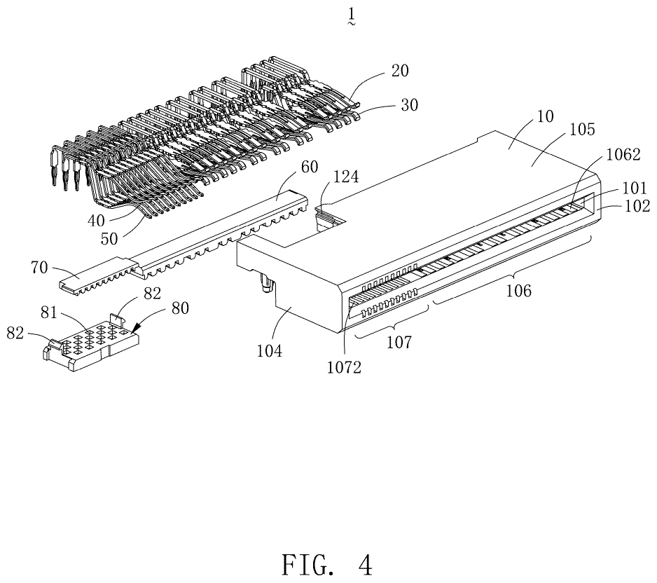

Please refer to FIGS. 4, 7 and 8, the insulation case 10 is longitudinally elongated. The insulation case 10 has a mating side 102, a terminal insertion side 103, an installation side 104 and a pressure application side 105. The mating side 102 is arranged opposite to the terminal insertion side 103. The installation side 104 is arranged opposite to the pressure application side 105. The installation side 104 is perpendicular to the mating side 102 and the terminal insertion side 103. The slot 101 is elongated and formed on the mating side 102.

Please refer to FIGS. 4 and 7, the insulation case 10 has a power terminal placement area 106 and a signal terminal placement area 107 adjacent to each other. In the power terminal placement area 106, the insulation case 10 is provided with a plurality of first power terminal-receiving slots 1061 and a plurality of second power terminal-receiving slots 1062. The first power terminal-receiving slots 1061 are arranged in a row and pass through the mating side 102 and the terminal insertion side 103 for receiving the first power terminals 20. The second power terminal-receiving slots 1062 are arranged in a row and pass through the mating side 102 and the terminal insertion side 103 for receiving the second power terminals 30. In the signal terminal placement area 107, the insulation case 10 is provided with a plurality of first signal terminal-receiving slots 1071 and a plurality of second signal terminal-receiving slots 1072. The first signal terminal-receiving slots 1071 are arranged in a row and pass through the mating side 102 and the terminal insertion side 103 for receiving the first signal terminals 40. The second signal terminal-receiving slots 1072 are arranged in a row and pass through the mating side 102 and the terminal insertion side 103 for receiving the second signal terminals 50.

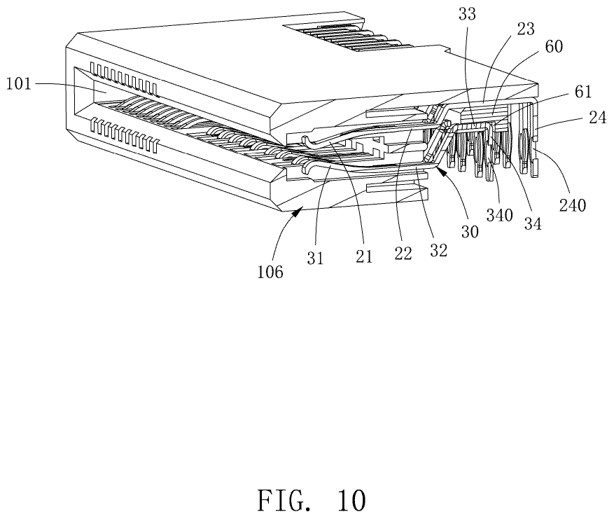

In the power terminal placement area 106, as shown in FIG. 10, the first elastic arm 21 and the corresponding second elastic arm 31 extend into the slot 101, are arranged vertically, and form a clamping shape to clamp the insert 9. The first retaining section 22 and the second retaining section 32 are respectively fixed in the first power terminal-receiving slot 1061 and the second power terminal-receiving slot 1062 by barbs. The first horizontal section 23 and the second horizontal section 33 are located on the terminal insertion side 103 and are respectively located out of the first power terminal-receiving slot 1061 and the second power terminal-receiving slot 1062. The first vertical section 24 and the second vertical section 34 stand upright on the terminal insertion side 103. The first power press fit pin 240 and the second power press fit pin 340 are located on the terminal insertion side 103 and extend toward the installation side 104.

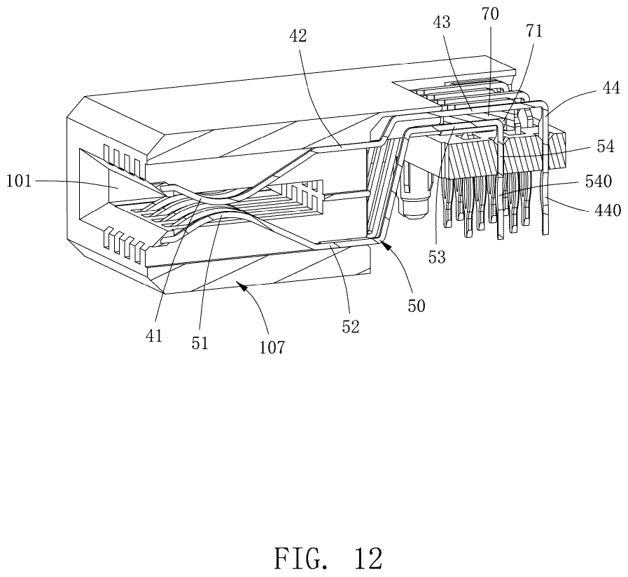

In the signal terminal placement area 107, as shown in FIG. 12, the first front arm 41 and the corresponding second front arm 51 extend into the slot 101, are arranged vertically, and form a clamping shape to clamp the insert 9. The first locking section 42 and the second locking section 52 are respectively fixed in the first signal terminal-receiving slot 1071 and the second signal terminal-receiving slot 1072 by barbs. The first transverse section 43 and the second transverse section 53 are located on the terminal insertion side 103 and are respectively located out of the first signal terminal-receiving slot 1071 and the second signal terminal-receiving slot 1072. The first longitudinal section 44 and the second longitudinal section 54 stand upright on the terminal insertion side 103. The first signal press fit pin 440 and the second signal press fit pin 540 are located on the terminal insertion side 103 and extend toward the installation side 104.

In the power terminal placement area 106, as shown in FIG. 7, the insulation case 10 has a power cover plate 11, a first vertical wall 111 and a second vertical wall 112. The first vertical wall 111 and the second vertical wall 112 face each other. The power cover plate 11, the first vertical wall 111 and the second vertical wall 112 surround the plurality of first power terminal-receiving slots 1061 and the plurality of second power terminal-receiving slots 1062 on the terminal insertion side 103. Specifically, the power cover plate 11 is located on the pressure application side 105 and the terminal insertion side 103, extends in a direction away from the mating side 103, and is used to cover the first power terminal 20 and the second power terminal 30. The first vertical wall 111 and the second vertical wall 112 are located below the power cover plate 11 and are vertically connected to the power cover plate 11. The first vertical wall 111 and the second vertical wall 112 are each provided with a first holding groove 113 thereon. Two ends of the first support plate 60 are each provided with a first protrusion rib 62, which can slide into the first holding groove 113 for fixing the first support plate 60 to the insulation case 10.

In the signal terminal placement area 107, the insulation case 10 is provided with an opening 12, a third vertical wall 121 and a fourth vertical wall 122. The opening 12, the third vertical wall 121 and the fourth vertical wall 122 surround the plurality of first signal terminal-receiving slots 1071 and the plurality of second signal terminal-receiving slots 1072 on the terminal insertion side 103. Specifically, the opening 12 is located on the pressure application side 105 and is adjacent to the power cover plate 11. The third vertical wall 121 and the fourth vertical wall 122 face each other, are located on two sides of the opening 12 and are parallel to the first vertical wall 111 and the second vertical wall 112. The third vertical wall 121 and the fourth vertical wall 122 are each provided with a second holding groove 123. Two ends of the second support plate 70 are each provided with a second protrusion rib 72, which can slide into the second holding groove 123 for fixing the second support plate 70 to the insulation case 10.

Please refer to FIG. 7, the insulation case 10 is provided with a first bearing block 13, a second bearing block 14 and a partition plate 15. The first bearing block 13 and the second bearing block 14 are disposed on two ends of the insulation case 10, are located on the terminal insertion side 103 and extend in a direction away from the mating side 102. The partition plate 15 is located between the first bearing block 13 and the second bearing block 14 and also located between the power terminal placement area 106 and the signal terminal placement area 107. The first bearing block 13 is located below the power cover plate 11. The second bearing block 14 and the partition plate 15 are arranged opposite to each other and commonly define the opening 12. Wherein, one side wall (i.e. an inner wall) of the first bearing block 13 facing the partition plate 15 is the first vertical wall 111. Two opposite side walls of the partition plate 15 are second vertical wall 112 and the third vertical wall 121, respectively. One side wall (i.e. an inner wall) of the second bearing block 14 facing the partition plate 15 is the fourth vertical wall 122.

Referring to FIG. 7, the insulation case 10 is provided with two positioning posts 16, which are respectively located on bottom surfaces of the first bearing block 13 and the second bearing block 14 and extend vertically toward the installation side 104.

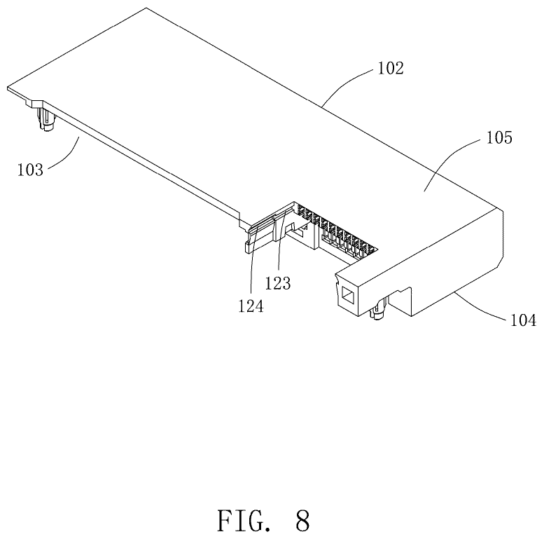

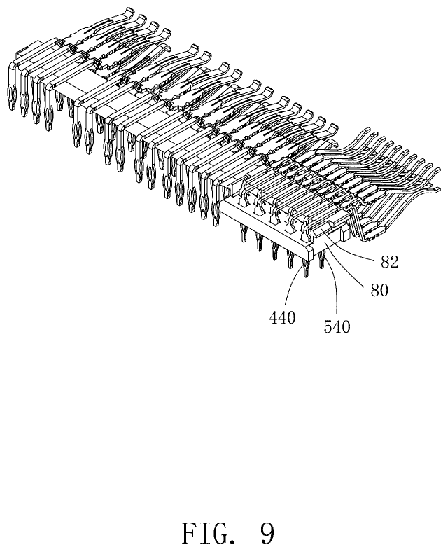

Please refer to FIGS. 4, 7 and 9, the press fit connector 1 further includes a terminal seat 80, which is provided with a plurality of position holes 81 for positioning the first signal terminals 40 and the second signal terminals 50. wherein, the first and second press fit pins 440, 540 extend out from a bottom surface of the terminal seat 80 and are located below the terminal seat 80. The terminal seat 80 is further provided with two latch arms 82 disposed on two ends of the terminal seat 80. The third vertical wall 121 and the fourth vertical wall 122 are each provided with a fastening groove 124. Each latch arm 82 enters into the corresponding fastening groove 124 for fixing the terminal seat 80 on the insulation case 10. Referring to FIGS. 7 and 8, the fastening groove 124 and the corresponding second holding groove 123 are located at the same height and are linearly aligned for being communicated with each other. The second protruding rib 72 can pass through the fastening groove 124 and enter into the second holding groove 123.

As described above, the press fit connector 1 of the present application can be safely pressed onto the circuit board by providing the first support plate 60 and the second support plate 70. The power terminals of the press fit connector 1 of the present application can provide good power transmission, and the signal terminals thereof can provides good signal transmission functions.

It should be understood that, the application of the present application is not limited to the above examples listed. Ordinary technical personnel in this field can improve or change the applications according to the above descriptions, all of these improvements and transforms should belong to the scope of protection in the appended claims of the present application.

What is claimed is:

1. A press fit connector, comprising:
an insulation case, having a slot for inserting an insert;
a plurality of first power terminals, each of which has a first elastic arm, a first retaining section, a first horizontal section and a first vertical section arranged in sequence; the first vertical section disposing a first power press fit pin;
a plurality of second power terminals, each of which has a second elastic arm, a second retaining section, a second horizontal section and a second vertical section arranged in sequence; the second vertical section disposing a second power press fit pin; wherein, the first elastic arm and the corresponding second elastic arm extend into the slot, are arranged vertically, and form a clamping shape to clamp the insert; the first horizontal section and the corresponding second horizontal section being arranged vertically and forming a first spacing;
a plurality of first signal terminals, each of which has a first front arm, a first locking section, a first transverse section and a first longitudinal section arranged in sequence; the first longitudinal section disposing a first signal press fit pin;
a plurality of second signal terminals, each of which has a second front arm, a second locking section, a second transverse section and a second longitudinal section arranged in sequence; the second longitudinal section disposing a second signal press fit pin; wherein, the first front arm and the corresponding second front arm extend into the slot, are arranged vertically, and form a clamping shape to clamp the insert; the first transverse section and the corresponding second transverse section being arranged vertically and forming a second spacing;
a first support plate, having a plurality of first support grooves arranged in a row and located in the first spacing; wherein the second horizontal section of each second power terminal is embedded in the corresponding first support groove; and
a second support plate, having a plurality of second support grooves arranged in a row and located in the second spacing; wherein the second transverse section of each second signal terminal is embedded in the corresponding second support groove.

2. The press fit connector according to claim 1, wherein,
each of the first support grooves has an L-shaped cross-section along the second horizontal section, and a U-shaped cross-section perpendicular to the second horizontal section; and
each of the second support grooves has an L-shaped cross-section along the second transverse section, and a U-shaped cross-section perpendicular to the second transverse section.

3. The press fit connector according to claim 1, wherein,
the insulation case has a mating side, a terminal insertion side, an installation side and a pressure application side;
the mating side is arranged opposite to the terminal insertion side; the installation side is arranged opposite to the pressure application side; and the installation side is perpendicular to the mating side and the terminal insertion side;
the slot is formed on the mating side;
the first vertical sections, the second vertical sections, the first longitudinal sections and the second longitudinal sections are exposed on the terminal insertion side; and
the first power press fit pins, the second power press fit pins, the first signal press fit pins and the second signal press fit pins are located on the terminal insertion side and extend toward the installation side.

4. The press fit connector according to claim 3, wherein,
the insulation case has a power terminal placement area and a signal terminal placement area adjacent to each other;
in the power terminal placement area, the insulation case includes:
a power cover plate, being located on the pressure application side, extending in a direction away from the mating side, and being used to cover the first power terminal and the second power terminal; and
a first vertical wall and a second vertical wall, facing each other, being located below the power cover plate and being vertically connected to the power cover plate;
wherein, the first vertical wall and the second vertical wall are each provided with a first holding groove; and
wherein, two ends of the first support plate are each provided with a first protrusion rib, which can slide into the first holding groove for fixing the first support plate to the insulation case.

5. The press fit connector according to claim 4, wherein,
in the signal terminal placement area, the insulation case is provided with:
an opening, being located on the pressure application side and being adjacent to the power cover plate; and
a third vertical wall and a fourth vertical wall, facing each other, being located on two sides of the opening and being parallel to the first and second vertical walls;
wherein, the third vertical wall and the fourth vertical wall are each provided with a second holding groove; and
wherein, two ends of the second support plate are each provided with a second protrusion rib, which can slide into the second holding groove for fixing the second support plate to the insulation case.

6. The press fit connector according to claim 5, wherein,
the insulation case is provided with a partition plate located between the power terminal placement area and the signal terminal placement area; and
the second vertical wall and the third vertical wall are two opposite side walls of the partition plate.

7. The press fit connector according to claim 6, wherein,
the insulation case is provided with a first bearing block and a second bearing block, which are disposed on two ends of the insulation case, are located on the terminal insertion side and extend in a direction away from the mating side;
wherein, the first bearing block is located below the power cover plate, and one side wall of the first bearing block facing the partition plate is the first vertical wall; and
wherein, the second bearing block and the partition plate are arranged opposite to each other and define the opening; one side wall of the second bearing block facing the partition plate is the fourth vertical wall.

8. The press fit connector according to claim 7, wherein,
the insulation case is provided with two positioning posts, which are respectively located on bottom surfaces of the first bearing block and the second bearing block and extend toward the installation side.

9. The press fit connector according to claim 5, further comprising:
a terminal seat, being provided with a plurality of position holes for positioning the first signal terminals and the second signal terminals, and two latch arms disposed on two ends of the terminal seat;
wherein, the first and second press fit pins extend out from a bottom surface of the terminal seat; and
wherein, the third vertical wall and the fourth vertical wall are each provided with a fastening groove; each latch arm enters into the corresponding fastening groove for fixing the terminal seat on the insulation case; each fastening groove is communicated with the corresponding second holding groove; the second protruding rib passes through the fastening groove and enters into the second holding groove.

10. The press fit connector according to claim 5, wherein,
in the power terminal placement area, the insulation case is provided with:
a plurality of first power terminal-receiving slots, being arranged in a row and passing through the mating side and the terminal insertion side for receiving the first power terminals; and
a plurality of second power terminal-receiving slots, being arranged in a row and passing through the mating side and the terminal insertion side for receiving the second power terminals;
wherein, the power cover plate, the first vertical wall and the second vertical wall surround the first power terminal-receiving slots and the second power terminal-receiving slots on the terminal insertion side;
in the signal terminal placement area, the insulation case is provided with:
a plurality of first signal terminal-receiving slots, being arranged in a row and passing through the mating side and the terminal insertion side for receiving the first signal terminals; and
a plurality of second signal terminal-receiving slots, being arranged in a row and passing through the mating side and the terminal insertion side for receiving the second signal terminals;
wherein, the opening, the third vertical wall and the fourth vertical wall surround the first signal terminal-receiving slots and the second signal terminal-receiving slots on the terminal insertion side.

11. The press fit connector according to claim 1, wherein,
the first power press fit pins, the second power press fit pins, the first signal press fit pins and the second signal press fit pins are all eyelet-type press fit pins.

12. The press fit connector according to claim 1, wherein,
the first retaining section and the second retaining section are parallel to each other and forms a third spacing, and the third spacing is greater than the first spacing;
the first locking section and the second locking section are parallel to each other and forms a fourth spacing, and the fourth spacing is greater than the second spacing;
wherein, the third spacing is less than the fourth spacing, and the first spacing is greater than the second spacing.
